(19) United States
(12) Patent Application Publication
(10) Pub. No.: US 2024/0042358 A1
(43) Pub. Date: Feb. 8, 2024

(54) LENS PROTECTION STRUCTURE

(71) Applicant: TRIPLE WIN TECHNOLOGY(SHENZHEN) CO.LTD., Shenzhen (CN)

(72) Inventors: SHU-QING HAO, Jincheng (CN); SHENG-JIE DING, Jincheng (CN); DING-NAN HUANG, New Taipei (TW); RUI ZHANG, Jincheng (CN)

(21) Appl. No.: 17/944,360

(22) Filed: Sep. 14, 2022

(30) Foreign Application Priority Data
Aug. 5, 2022 (CN) 202210938542.8

(51) Int. Cl. B01D 45/02; B01D 45/04; G02B 27/00

(52) U.S. Cl. CPC B01D 45/02; B01D 45/04; G02B 27/0006

(57) ABSTRACT

A lens protection structure comprising a main body configured for defining a receiving space by being attached to a lens module, the receiving space is configured for receiving a lens of the lens module, the main body is arranged with an air escape structure for communicating the receiving space and external environment, the air escape structure comprises: an air flow channel, a diversion connected in the air flow channel for diverting the airflow therethrough, and a retention connecting to the diversion for harvesting impurities and dust carried in air flow through the air escape structure. Therefore, the lens protection structure prevents the lens from being damaged in processing and transporting while provides communication between the receiving space and the external environment.

### CROSS-REFERENCE TO RELATED APPLICATION

This application claims priority to China Application No. 202210938542.8, having a filing date of Aug. 5, 2022, filed in China State Intellectual Property Administration, the entire contents of which are hereby incorporate by reference.

### FIELD

The subject matter relates to electronics and optical devices, and more particularly to a lens protection structure.

### BACKGROUND

During the production and processing of lens modules, a lens installed on a lens holder should be protected by a protection structure, because a surface of the lens is fragile and some impurities and dust will contaminate the lens. The protection structures, such as foam protection structures, has good air permeability and can avoid the formation of a closed space between the lens and the protective structure. However, the foam protection structure is relatively easy to break to produce debris, which will contaminate the lens. Injection-molded structures are used to eliminate above-mentioned defects. However, such injection-molded structure forms a closed space between the lens and the protection structure, and the air will expand when the lens module being heated, which may plump up the protective film of the protection structure or cause the protection structure to separate from the lens. Therefore, the injection-molded structure needs to be arranged with an escape hole for gas discharge, to avoid the formation of a closed space.

However, although the air escape hole structure of the existing injection-molded protective film avoids the formation of a closed space between the lens and the protective film, it is difficult to prevent impurities and dust such as external dust from entering the protective film, and then adhering to the lens and contaminating the lens.

### SUMMARY

An objective of the present disclosure is achieved by providing a lens protection structure, technical solutions adopted by the present disclosure are as follows:

An aspect of the present disclosure provides a lens protection structure comprising: a main body defining a receiving space by attaching to a lens module, the receiving space being configured for receiving a lens of the lens module, the main body comprising an air escape structure, the receiving space being connected to an external environment via the air escape structure.

The air escape structure comprises an air flow channel comprising a first opening communicating with the external environment and a second opening communicating with the receiving space; a diversion connected in the air flow channel, the diversion diverting airflows therethrough; and a retention connecting to the diversion, the retention harvesting impurities and dust in airflows through the air escape structure.

Therefore, the lens of the lens module can be received in the receiving space as the lens protection structure is attached to the lens module, which prevent the lens from being damaged in following processing and transporting. The air escape structure provides communication between the receiving space and the external environment while preventing the impurities and dust to enter the receiving space from the external environment by retaining the impurities and dust in the retention.

Preferably, the retention comprises one or more pit traps configured for harvesting impurities and dust in the airflows, and the pit trap are depressions connected to the air flow channel at the diversion.

Preferably, the main body comprising: a base; a protective film cover on the base; a layer of glue between the base and the lens module; wherein each of the base and the layer of glue defines a through hole, the through holes cooperatively defining a receiving space for receiving the lens of the lens module; the base comprises a side wall defining a perimeter of the receiving space, the side wall comprises a first surface and a second surface opposite to the first surface, the protective film being covered on the first surface, the base being attached to the lens module on the second surface via the layer of glue, the air escape structure being arranged in the side wall.

Preferably, the air flow channel comprising: a first transverse channel arranged in the side wall of the base and extending parallel to the first surface, the first transverse channel connecting to the first opening to the external environment; a second transverse channel arranged in the side wall of the base and extending parallel to the second surface, the second transverse channel connecting the second opening to the receiving space, and a vertical channel connecting the first transverse channel and the second transverse channel; wherein the diversion is arranged at each of the connection between the first transverse channel and the vertical channel and the connection between the second transverse channel and the vertical channel; the retention comprises a pit trap, the pit trap being connected to the diversion that arranged at the connection between the second transverse channel and the vertical channel, and the pit trap is connected at the bottom of the vertical channel and extends in along the vertical channel.

Preferably, the retention further comprises a secondary pit trap, the secondary pit trap being connected to the diversion that arranged at the connection between the first transverse channel and the vertical channel, and the secondary pit trap extends along the direction of the first transverse channel.

Preferably, a first transverse channel arranged in the side wall of the base and extending parallel to the first surface, the first transverse channel connecting the first opening to the external environment; a second transverse channel arranged in the side wall of the base and extending parallel to the second surface, the second transverse channel connecting the second opening to the receiving space, and a vertical channel comprising a first hole and a second hole parallel to the first hole, wherein the second hole is displaced from the first hole with a distance smaller than a sum of radius of the first hole and the second hole so that the first hole and the second hole are overlapped and connected at their side walls.

The first hole is connected to the first transverse channel at one end and connected to the second hole at the other end, the second hole is connected to the first hole and is connected to the second transverse channel at the other end; and the diversion is arranged at each of the connection of the first transverse channel and the first hole, the connection of the first hole and the second hole, and the connection of the second hole and the second transverse channel, the retention comprises a pit trap arranged at the connection of the first hole and the second hole, the pit trap is connected at bottom of the first hole and extends along the first hole, a barrier is arranged between the pit trap and the second hole.

Preferably, the pit trap is shaped as a cone or a pyramid.

Preferably, a size of the pit trap is gradually decreased along a direction away from the air flow channel.

Preferably, the pit trap comprises a tacky portion for harvesting the impurities and dust.

Preferably, each of the first hole and the second hole has a diameter larger than 0.5 mm.

Preferably, the base is made of injection molding materials.

### BRIEF DESCRIPTION OF THE DRAWINGS

Implementations of the present technology will now be described, by way of example only, with reference to the attached figures.

FIG. 1 is a perspective view of a lens protection structure attached to a lens module according to a first embodiment of the present disclosure;

FIG. 2 is an exploded view of the lens protection structure in FIG. 1;

FIG. 3 is a cross section view of a side wall of a base of the lens protection structure in FIG. 2;

FIG. 4 is a cross section view of a side wall of a base of the lens protection structure according to a second embodiment of the present disclosure;

FIG. 5 is a cross section view of a side wall of a base of the lens protection structure according to a third embodiment of the present disclosure;

FIG. 6 is a cross section view of a side wall of a base of the lens protection structure according to a fourth embodiment of the present disclosure;

FIG. 7 is an air escape structure of the lens protection structure according to a fifth embodiment of the present disclosure;

FIG. 8 is a cross section view of a side wall of a base of the lens protection structure in FIG. 7.

### DETAILED DESCRIPTION

It will be appreciated that for simplicity and clarity of illustration, where appropriate, reference numerals have been repeated among the different figures to indicate corresponding or analogous components. The description is not to be considered as limiting the scope of the embodiments described herein. The drawings are not necessarily to scale and the proportions of certain parts may be exaggerated to better illustrate details and features of the present disclosure.

It should be understood that, the terms “first” and “second” are used to distinguish elements and are not used to denote a particular order or imply a number of technical features, therefore, unless being specifically defined, features described as “first” and “second” may expressly or implicitly include one or more of the stated features. In the description of the present application, “plurality” means two or more, unless otherwise expressly and specifically defined.

In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described.

The term “comprising,” when utilized, means “including, but not necessarily limited to”; it specifically indicates open-ended inclusion or membership in the so-described combination, group, series, and the like.

A detailed description of the hereinafter described embodiments of the disclosure is presented herein by way of exemplification and not as limitation with reference to the figures.

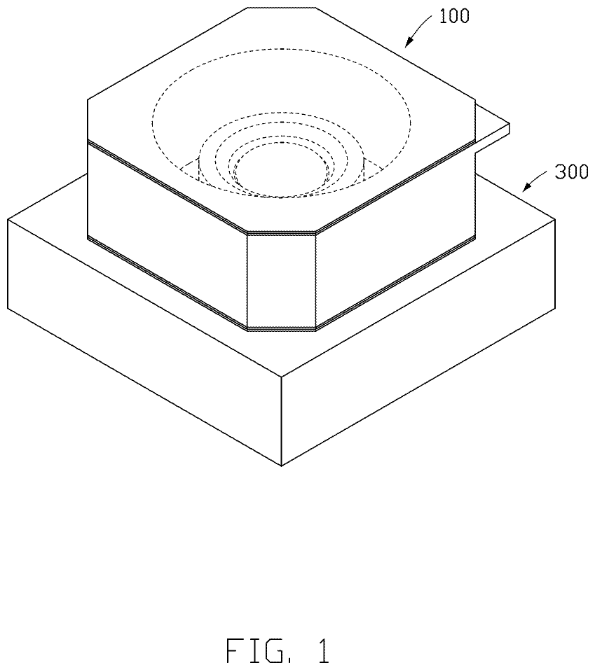

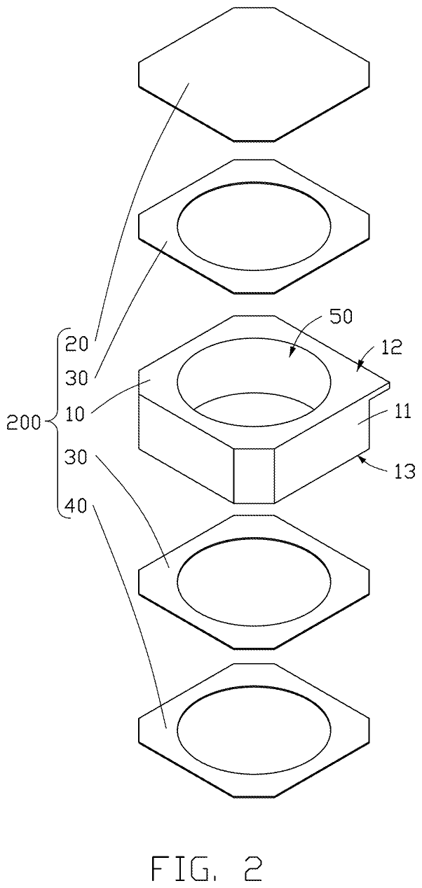

Referring to FIGS. 1-2, a lens protection structure 100 is provided. The lens protection structure 100 includes a main body 200, the main body 200 includes a base 10, a protective film 20, a first layer 30 of glue, and a second layer 40 of glue, wherein the protective film 20 is attached to the base 10 via one first layer 30, the base 10 is attached to a lens module 300 via one first layer 30 and one second layer 40, thereby adhering the lens protection structure 100 to the lens module 300. In particular, each of the base 10, the protective film 20, the first layer 30 of glue, and the second layer 40 of glue is a substantially hollow structure for defining a receiving space 50 for the lens of the lens module 300 when the lens protection structure 100 is attached to the lens module 300. The base 10 includes a side wall 11 encircle the lens and the protective film 20 is configured as a cover on the first layer 30, then the lens is enclosed in the lens protection structure 100.

In this embodiment, the base 10 is made of injection molding materials such as silica gel, and shaped as a rectangular frame comprising a first surface 11 and a second surface 12 opposite to the first surface 11, the protective film 20 is attached to the first surface 12 by the first layer 30, the base 10 is attached to the lens module 300 by the first layer 30 and the second layer 40, thereby defining the receiving space 50 for the lens of the lens module 300.

It should be noted that, the protective film 20 can be attached to the base 10 by other means, for example, the protective film 20 is mounted to the base 10 by fasteners such as screws or snap clips, or the protective film 20 itself is adhesive. In further embodiments, the first layer 30 between the base 10 and the lens module 300 can be removed, and the base 10 and the lens module 300 can be connected by merely the second layer 40. In this embodiment, the first layer 30 is a double side tape, the second layer 40 is an antistatic silica gel, the protective film 20 is a PET film, in further embodiment, the protective film 20 can be any kind of high transmittance thin films or panels such as polyester films.

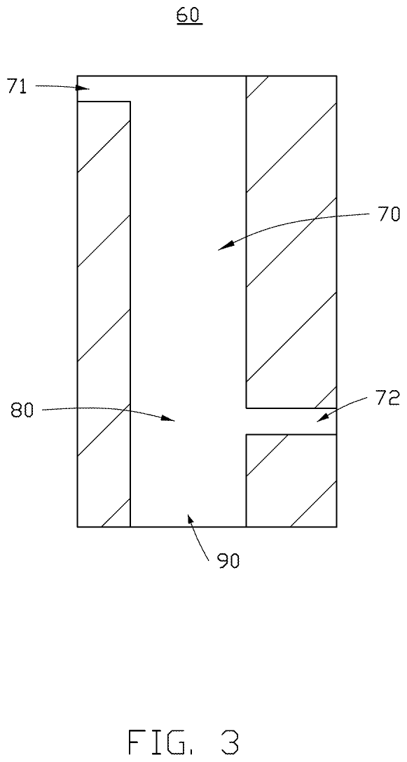

Referring to FIG. 3, an air escape structure 60 is arranged on the side wall 11 of the base 10, the air escape structure 60 comprises an air flow channel 70, a diversion 80 connected in the air flow channel 70, and a retention 90 connected to the diversion 80. In particular, the flow channel 70 is arranged with a first opening 71 communicating with external environment and a second opening 72 communicating with the receiving space 50 (as shown in FIG. 2), the diversion 80 is connected in the air flow channel 70 for diverting the airflow therethrough, that means the diversion 80 is part of the air flow channel 70, the air enters from the first opening 71 will be obstructed by the diversion 80 and won't flow smoothly through the air flow channel 70 to the receiving space 50 via second opening 72 and enter. The retention 90 connecting to the diversion 80 extends from the diversion 80 in direction of the airflow enters the air flow channel 70 from the first opening 71, allowing the airflow to divert to leave the retention 90, then impurities and dust in the airflow can hardly leave with the airflow and will be retained in the retention 90. Therefore, the airflow enters the air flow channel 70 from the first opening 71, then flows straightly into the diversion 80 and the retention 90, then the airflow turns to leave the retention 90 with the impurities and dust therein being left in the retention due to inertance and gravity.

Therefore, the lens of the lens module can be received in the receiving space 50 as the lens protection structure 100 is attached to the lens module, which prevent the lens from being damaged in following processing and transporting. The air escape structure 60 provides communication between the receiving space 50 and the external environment while preventing the impurities and dust to enter the receiving space 50 from the external environment by retaining the impurities and dust in the retention 90.

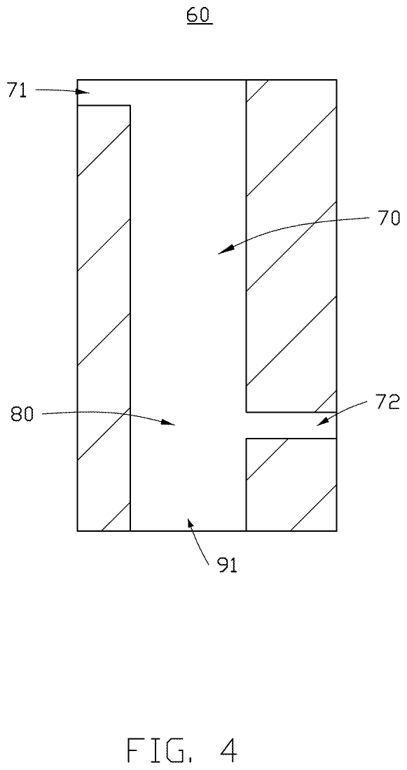

Referring to FIG. 4, in further embodiments, the retention 90 comprises a pit trap 91 for storing the impurities and dust in the airflow. The pit trap 91 is connected in the air flow channel 70 at the diversion and is formed as a detention extends from the diversion 80, and the direction of extension is the direction of the airflow enters the air flow channel 70 from the first opening 71, thereby the airflow enters the air flow channel 70 and goes directly into the pit trap 91 at the diversion 80, then diverts to go back into the air flow channel 70 to flow through and enter the receiving space 50 from the second opening 72, the impurities and dust in the airflow will be retained in the pit trap 91 due to inertance and gravity.

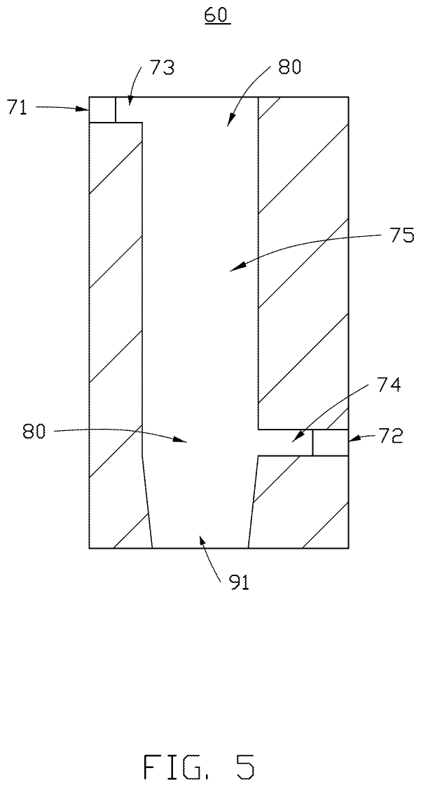

Referring to FIG. 5, in further embodiments, the air flow channel 70 comprises a first transverse channel 73, a second transverse channel 74, and a vertical channel 75, wherein the first transverse channel 73 is arranged in the side wall 11 of the base 10 and extends parallel to the first surface 11 to connect to the first opening 71 for communicating with the external environment, the second transverse channel 74 is arranged in the side wall 11 of the base 10 and extends parallel to the second surface 12 to connect to the second opening 72 for communicating with the receiving space 50, the first transverse channel 73 and the second transverse channel 74 are connected by the vertical channel 74, the diversion 80 is arranged at the connection between the first transverse channel 73 and the vertical channel 75 and the connection between the second transverse channel 74 and the vertical channel 75, that means, the air flow form the external environment to the receiving space 50 via the air flow channel 70 need to divert twice at the two diversions 80. In this embodiment, the retention 90 comprises a pit trap 91 connected to the diversion 80 arranged at the connection between the second transverse channel 74 and the vertical channel 75, and the pit trap 91 is connected at the bottom of the vertical channel 75, therefore, the airflow in the vertical channel 75 enters the pit trap 91 firstly, then turns to enter the second transverse channel 74 with the impurities and dust left in the pit trap 91.

Therefore, the airflow enters the air flow channel 70 from the first opening 71 flows in direction from the first surface 12 to the second surface 13 when passing the vertical channel 75, then the airflow carries the impurities and dust to the pit trap 91 before it turns to the second transverse channel 74 and the impurities and dust can hardly leave the pit trap 91 due to inertance and gravity.

In further embodiments, a size of the pit trap 91 is gradually decreased along a direction away from the air flow channel 70. As shown in FIG. 5, the pit trap 91 is shaped as a cone and the size of the pit trap 91 is gradually decreased along a direction from the first surface 12 to the second surface 13.

Therefore, the retained dust and impurities can slide or roll along the gradient wall of the pit trap 91 and being collected at bottom of the pit trap 91, which prevents the impurities and dust gathered near the diversion 80 or the air flow channel 70 to obstruct the airflow.

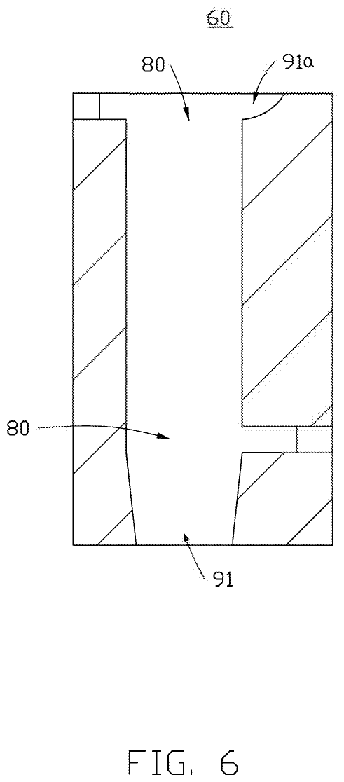

In further embodiments, referring to FIG. 6, the diversion 80 further comprises a secondary pit trap 91a connected to the diversion 80 arranged at the connection between the first transverse channel 73 and the vertical channel 75, and the secondary pit trap 91a extends along the direction of the first transverse channel 73, therefore, the airflow enters this secondary pit trap 91a before turns to enter the vertical channel 75, and at least part of the impurities and dust is left in the secondary pit trap 91a, then the airflow enters the pit trap 91 connected at bottom of the vertical channel 75 and leave the other impurities and dust therein, therefore, in this embodiment, the airflow diverts twice and the impurities and dust are collected twice, which further prevents the impurities and dust to enter the receiving space 50.

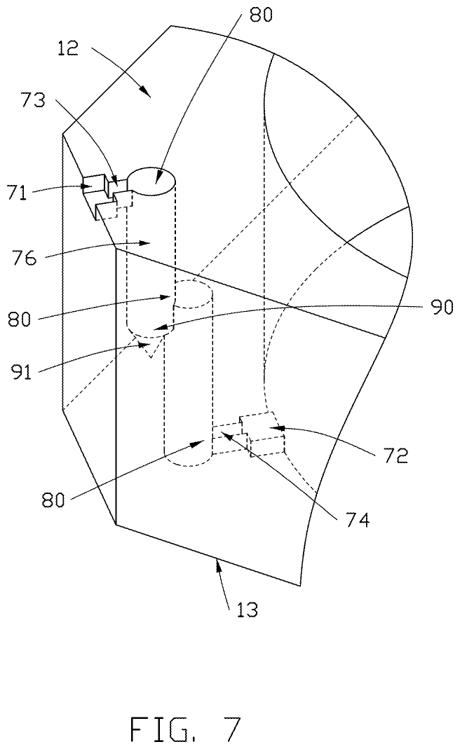

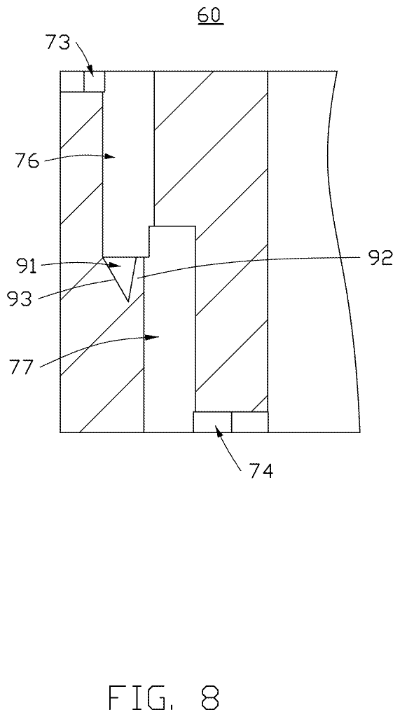

In further embodiments, referring to FIGS. 7-8, the vertical channel 75 comprises a first hole 76 and a second hole 77 parallel to the first hole 76, the second hole 76 is displaced from the first hole 76 with a distance smaller than sum of radius of the first hole 76 and the second hole 77 so that the first hole 76 and the second hole 77 are overlapped to connected at their side wall while the airflow pass the vertical channel 75 requires to turn at the connection. Further, the first hole 76 is connected to the first transverse channel 73 at one end and connected to the second hole 77 at the other end, the second hole 77 is connected to the first hole 76 and is connected to the second transverse channel 74 at the other end, the length of overlapped portion is no larger than 1.5 times the height of any of the first transverse channel 73 and the second transverse channel 74. The diversion 80 is arranged at the connection of the first transverse channel 73 and the first hole 76, the connection of the first hole 76 and the second hole 77, and the connection of the second hole 77 and the second transverse channel 74, the retention 90 comprises a pit trap 91 arranged at the connection of the first hole 76 and the second hole 77, the pit trap 91 is connected at bottom of the first hole 76 and extends in direction of the first hole 76, a barrier 92 is arranged between the pit trap 91 and the second hole 77 for preventing the impurities and dust escape from the pit trap 91.

Therefore, the airflow entering the air flow channel 70 from the first opening 71 enters the pit trap 91 together with the impurities and dust carried by the airflow when passing by the diversion 80 at the connection between the first hole 76 and the second hole 77, then the airflow turns into the second hole while the impurities and dust are prevented from leaving the pit trap 91 by the barrier 92.

In further embodiments, the pit trap 91 comprises a tacky portion 93 for harvesting the impurities and dust entering the pit trap 91. Referring to FIG. 8, the tacky portion 93 is arranged on side wall of the pit trap 91.

Therefore, the impurities and dust entering the pit trap 91 are adhered to the side wall of the pit trap 91 and can hardly escape from the pit trap 91 even the lens protection structure 100 and the lens module 300 are moved or turned over.

In further embodiments, the distance between the first transverse channel 73 and the first surface 12 is smaller than that of the second transverse channel 74 and the first surface 12, then the air flow channel 70 will always comprises a diversion 80 diverts the airflow towards the second surface 13 to the receiving space 50, and the pit trap 91 can be arranged at the diversion 80 and extends in direction of the airflow before it turns. Therefore, the impurities and dust carried by the airflow is more easily to be collected in the pit trap 91 with assistance of gravity.

In further embodiments, referring to FIG. 7, a width of the first opening 71 is larger than that of the first transverse channel 73, and a width of the second opening 72 is larger than that of the second transverse channel 74, therefore, the ventilation effect can be improved and it is harder for the impurities and dust carried by the airflow to enter the first transverse channel 73 from the first opening 71.

In this embodiment, each of the first transverse channel 73 and the second transverse channel 74 has a height of 0.2 mm and a width of 0.2 mm, each of the first opening 71 and the second opening 72 has a width of 0.5 mm. It should be noted that, the sizes are shown for exemplary, and should not be regarded as a limitation to the application. In further embodiments, the height and width of each the first transverse channel 73, the second transverse channel 74, the first opening 71, and the second opening 72 can be adjusted according to actual requirements.

In this embodiment, the air flow channel 70 has a diameter larger than 0.5 mm for ventilation, and for air flow channel 70 with larger diameter, the length of the first transverse channel 73 and the second transverse channel 74 will be short, which reduces probability of blockage in the first and second transverse channels 73, 74.

In this embodiment, each of the first hole 76 and the second hole 77 has a diameter of 0.5 mm for ventilation. Preferably, in further embodiments, the diameter of each of the first hole 76 and the second hole 77 can be larger than 0.5 mm, such as 0.6 mm, 0.7 mm, and so on.

While the invention has been described in detail in connection with only a limited number of embodiments, it should be readily understood for the skilled in the art that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A lens protection structure comprising:
a main body defining a receiving space by attaching to a lens module, the receiving space being configured for receiving a lens of the lens module, the main body comprising an air escape structure, the receiving space being connected to an external environment via the air escape structure, wherein
the air escape structure comprises:
an air flow channel comprising a first opening communicating with the external environment and a second opening communicating with the receiving space;
a diversion connected in the air flow channel, the diversion diverting airflows therethrough; and
a retention connecting to the diversion, the retention harvesting impurities and dust in airflows through the air escape structure.

2. The lens protection structure of claim 1, wherein the retention comprises one or more pit traps configured for harvesting impurities and dust in the airflows, and the pit trap are depressions connected to the air flow channel at the diversion.

3. The lens protection structure of claim 1, wherein the main body comprising:
a base;
a protective film cover on the base;
a layer of glue between the base and the lens module; wherein
each of the base and the layer of glue defines a through hole, the through holes cooperatively defining a receiving space for receiving the lens of the lens module;
the base comprises a side wall defining a perimeter of the receiving space, the side wall comprises a first surface and a second surface opposite to the first surface, the protective film being covered on the first surface, the base being attached to the lens module on the second surface via the layer of glue, the air escape structure being arranged in the side wall.

4. The lens protection structure of claim 3, wherein the air flow channel comprising:
a first transverse channel arranged in the side wall of the base and extending parallel to the first surface, the first transverse channel connecting to the first opening to the external environment;
a second transverse channel arranged in the side wall of the base and extending parallel to the second surface, the second transverse channel connecting the second opening to the receiving space, and
a vertical channel connecting the first transverse channel and the second transverse channel; wherein
the diversion is arranged at each of the connection between the first transverse channel and the vertical channel and the connection between the second transverse channel and the vertical channel;
the retention comprises a pit trap, the pit trap being connected to the diversion that arranged at the connection between the second transverse channel and the vertical channel, and the pit trap is connected at the bottom of the vertical channel and extends in along the vertical channel.

5. The lens protection structure of claim 4, wherein
the retention further comprises a secondary pit trap, the secondary pit trap being connected to the diversion that arranged at the connection between the first transverse channel and the vertical channel, and the secondary pit trap extends along the direction of the first transverse channel.

6. The lens protection structure of claim 3, wherein the air flow channel comprising:
a first transverse channel arranged in the side wall of the base and extending parallel to the first surface, the first transverse channel connecting the first opening to the external environment;
a second transverse channel arranged in the side wall of the base and extending parallel to the second surface, the second transverse channel connecting the second opening to the receiving space, and
a vertical channel comprising a first hole and a second hole parallel to the first hole, wherein
the second hole is displaced from the first hole with a distance smaller than a sum of radius of the first hole and the second hole so that the first hole and the second hole are overlapped and connected at their side walls;
the first hole is connected to the first transverse channel at one end and connected to the second hole at the other end, the second hole is connected to the first hole and is connected to the second transverse channel at the other end; and
the diversion is arranged at each of the connection of the first transverse channel and the first hole, the connection of the first hole and the second hole, and the connection of the second hole and the second transverse channel, the retention comprises a pit trap arranged at the connection of the first hole and the second hole, the pit trap is connected at bottom of the first hole and extends along the first hole, a barrier is arranged between the pit trap and the second hole.

7. The lens protection structure of claim 2, wherein the pit trap is shaped as a cone or a pyramid.

8. The lens protection structure of claim 2, wherein a size of the pit trap is gradually decreased along a direction away from the air flow channel.

9. The lens protection structure of claim 2, wherein the pit trap comprises a tacky portion for harvesting the impurities and dust.

10. The lens protection structure of claim 6, wherein each of the first hole and the second hole has a diameter larger than 0.5 mm.

11. The lens protection structure of claim 3, wherein the base is made of injection molding materials.
